(19) United States
(12) Patent Application Publication
(10) Pub. No.: US 2018/0189479 A1
(43) Pub. Date: Jul. 5, 2018

(54) VERIFICATION OF SECURITY DOMAIN SEPARATION

(71) Applicants: Mads DAM, Sollentuna (SE); Roberto GUANCIALE, Terni (IT); Narges KHAKPOUR, Boroujen Chahar-Mahal-o-Bakhtiyari (IR)

(72) Inventors: Mads DAM, Sollentuna (SE); Roberto GUANCIALE, Terni (IT); Narges KHAKPOUR, Boroujen Chahar-Mahal-o-Bakhtiyari (IR)

(21) Appl. No.: 14/890,032

(22) PCT Filed: Apr. 9, 2014
(86) PCT No.: PCT/EP2014/057115

§ 371 Date: Nov. 9, 2015

(30) Foreign Application Priority Data
May 8, 2013 (EP) PCT/EP2013/059602
Oct. 17, 2013 (EP) PCT/EP2013/071718

(51) Int. Cl. G06F 21/51; G06F 21/53; G06F 9/455; H04L 29/06

(52) U.S. Cl. CPC G06F 21/51; G06F 21/53; G06N 5/003; H04L 63/105; G06F 9/45558

(57) ABSTRACT

The disclosure concerns a security condition verification method for a system comprising first and second security domains relating to respective first and second functional modules, a security kernel and a shared hardware component. The functional modules are executed using the shared hardware component and the security condition comprises a condition that any information exchange between the functional modules is an authorized information exchange. The security kernel controls the execution of the first and second functional modules using the shared hardware component. The method comprises determining that the security condition is satisfied if, for each of the functional modules and for each initial state, a first observable parameter associated with execution of an instruction of the functional module using the shared hardware component equals a second observable parameter associated with execution of the instruction of the functional module using a dedicated model hardware component, wherein the executions have the initial states with equal observations. The dedicated model hardware component belongs to a model of the system wherein each functional module is adapted to be executed using a respective dedicated model hardware component and the set of authorized information exchange is respected by a communication unit operatively connected to each of the dedicated model hardware components via a respective security handler representing the security kernel control. The method also comprises generating a security condition satisfaction signal if it is determined that the security condition is satisfied. Corresponding computer program product, arrangement and electronic device are also disclosed.

### TECHNICAL FIELD

The present invention relates generally to the field of security (or isolation) verification. More particularly, it relates to verification that a security condition (or isolation condition) is fulfilled when a security kernel controls execution of functional modules of different security domains using a shared hardware component.

### BACKGROUND

Design of secure systems typically needs to ensure that software components (functional modules) belonging to different security domains are adequately isolated from each other, such that only authorized communication can take place between them. One way of achieving this is by dedicated hardware, e.g. Trusted Platform Module (TPM), Subscriber Identity Module (SIM), and the like. However, such approaches introduce significant overhead (e.g. the dedicated hardware itself and the associated infrastructure).

An alternative way to achieve the appropriate isolation is to execute the functional modules of different security domains in isolated partitions (also referred to as guests, or functional modules herein) on a shared set of hardware components using a low-level software execution platform controlling the execution to achieve the isolation. The low-level software execution platform may, for example, be a dedicated operating system, a hypervisor, a virtual machine monitor (VMM), or a separation kernel. The low-level execution platform is typically referred to herein as a security kernel, a kernel, or a hypervisor. To make an approach using a security kernel trustworthy it is beneficial that the security properties (e.g. isolation properties) of the execution platform may be carefully verified, preferably using formal methods. Thus, there is a need for methods and arrangements for formal security kernel verification.

The shared set of hardware components may comprise any suitable collection of one or more hardware components. Typically, the shared set of hardware components comprises one or more processor cores, one or more memory and/or memory caches (at different levels and with different access capabilities), one or more memory controllers, one or more bus controllers, and/or a collection of devices for networking, display, storage, etc. One role of the security kernel is to multiplex access of the partitions/domains/modules to the shared hardware while ensuring that the partitions/domains/modules interfere with each other only to the extent allowed by the applications (functional modules) executing in the different partitions. Since, the desires of partitions may be in conflict, the partitions cannot be allowed to determine the desired interference on their own. Usually, authorization security policies determine the extent to which the partitions can interfere with each other.

Examples situations of the above include:
The situation illustrated in FIG. 1, where a commodity operating system (OS) 210 (e.g. Android, iOS, Linux) is executing in one partition (termed user partition) using a shared Central Processing Unit (CPU) 240 and a virtual SIM application 220 (or another security critical application, e.g. a virtualized TPM (Trusted Personal Module)) is hosted by a second (secure) partition using the same CPU 240. In such a set-up, it may be the task of the kernel (hypervisor) 230 to ensure that critical data (e.g. encryption keys 221) are not leaked from the secure partition to the user partition as illustrated by 250.
A situation where a user partition is executing alongside a second (secure) partition performing security critical services (e.g. application monitoring, user authentication, authorization, etc.). In such a set-up, it may be the task of the kernel to hide the existence and operation of the security service applications from the user partition.
The situation illustrated in FIG. 2 (different situations in parts (a), (b) and (c)), where several virtual machines (VM) are executing, each in its respective partition in a cloud server architecture. In part (a), four different virtual machines 301, 302, 303, 304 of two different types (VM1, VM2) are executing in respective separate domains having a same security level (D2). The communications through the cloud server architecture is represented by 305. In part (b), two different virtual machines 311, 312 of two different types (VM1, VM2) are executing in respective separate domains having a same (high) security level (D1). The communications through the cloud server architecture is represented by 315. In part (c), the cloud server architecture hosts a large number of virtual machines 333, 334, 343, 344, 345, 346, 353, 354, 355 of different types (VM1, VM2, VM4) executing in respective separate domains having various security levels (D1, D2). The communications through the cloud server architecture is represented by 325 and may be controlled by a kernel. In part (c) some of the virtual machines are also hosted on a same CPU (331, 341, 351) and controlled by a CPU-specific kernel (hypervisor) 332, 342, 352. For example, the virtual machines 343, 344, 345 are executing on the shared CPU 341 and controlled by the hypervisor 342. In set-ups as those of FIG. 2, it may be the role of the (cloud) security kernel to provide virtualized network services to the virtual machines, and to ensure that the virtual machines are properly isolated from each other.
A situation of a virtualized application architecture in which multiple, mutually distrusting, objects or application instances each execute in their own partition, while sharing some components (e.g. one or more databases, registers, directories, or file repositories containing non-public data). In such a situation, it may be the task of the kernel to ensure that private data is not leaked from the repositories, or between the application instances.
The situation illustrated in FIG. 3, where each of one or several virtualized control processors (CNTR1, CNTR2, CNTR3, e.g. virtualized devices or device drivers) 411, 412, 413 (e.g. each related to one or more external devices 441, 442, 443, 444) is operating in its own partition on a shared CPU 430 under supervision of the security kernel (hypervisor) 420. In such a situation, the kernel may provide important safety or security-related checks, and ensure that faults do not propagate between partitions.

In each of these example scenarios, one security property (security condition, isolation condition) may be to ensure that confidential data (e.g. private or shared keys) and/or private application data is communicated between partitions only when allowed by the data owners' security policies. A second security property (security condition, isolation condition) may be to ensure that partitions cannot influence each other's execution (e.g. by propagating faults) if such influence is not intended by the system design.

Typically, a security kernel executes on the most privileged level of the software (e.g. corresponding to a high security execution mode) and manages (controls) the hardware and the execution of the partitions. An unprivileged security level (e.g. corresponding to a low security execution mode) may be used to execute the partitions and whenever a kernel functionality is invoked the system uses a high security (privileged) execution mode. In a fully virtualized environment, the interface between the kernel and the partitions may be identical to the interface between the hypervisor (kernel) itself and the hardware. In para-virtualized system, the hypervisor may provide an interface to the partitions that is similar, but not identical, to that provided by the hardware. One goal of para-virtualization is to reduce the complexity of the kernel, simplifying its code base and improving performance. Para-virtualization may typically require the partitions to be explicitly adapted to the kernel Application Programming Interface (API). Hence, in such an approach, the partitions are unable to run directly on the hardware without the support of the kernel.

In order to properly certify, be it formally or informally, the security of such a kernel, there is a need for a method to specify the desired security properties. There is also need for a method to prove that the specification holds for a given kernel design.

Such methods can be used, for instance, as a security specification to be exchanged between a cloud provider and its clients, for a systems developer or consultants to prove the security of a kernel design to a client, or for a device or operating systems vendor to certify a design or implementation, for instance using certification framework such as Common Criteria.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof.

It is an object of some embodiments to provide security verification methods and arrangements for systems with execution in two or more security domains.

According to a first aspect, a security condition verification method is provided of a system comprising first and second security domains relating to respective first and second functional modules, a security kernel and a shared hardware component, wherein each of the first and second functional modules is adapted to be executed using the shared hardware component, the security condition comprises a condition that any piece of information, originating from executing a first one of the functional modules and affecting execution of a second one of the functional modules, belongs to a set of authorized information exchange between the first and second security domains, and the security kernel is adapted to control the execution of the first and second functional modules.

The security condition may be an isolation property and/or an isolation condition.

In some embodiments, the security kernel is adapted to control the execution of the first and second functional modules such that the security condition is fulfilled.

The method may comprise determining that the security condition is satisfied if (for each of the functional modules, for each initial state, and for each instruction (e.g. an exception/interrupt)) a first observable parameter—associated with execution of the instruction of the functional module under control of the security kernel using the shared hardware component having the initial state—equals a second observable parameter—associated with execution of the instruction of the functional module using a dedicated model hardware component having the initial state—and generating a security condition satisfaction signal if it is determined that the security condition is satisfied.

According to some embodiments, the method comprises determining that the security condition is satisfied if, for each of the functional modules and for each initial state, a first observable parameter associated with execution of an instruction of the functional module using the shared hardware component equals a second observable parameter associated with execution of the instruction of the functional module using a dedicated model hardware component, wherein the executions have the initial states with equal observations.

The dedicated model hardware component belongs to a model of the system wherein each functional module is adapted to be executed using a respective dedicated model hardware component and the set of authorized information exchange is represented by a communication unit operatively connected to each of the dedicated model hardware components via a respective security handler (or ideal handler) representing the security kernel control.

In some embodiments, the method may comprise performing the following steps for each of the functional modules, for each of a set of initial states of the functional module, and for each of a set of instruction sequences for the functional module:
initiating the shared hardware component to the initial state;
executing the instruction sequence of the functional module under control of the security kernel using the shared hardware component while producing a corresponding first execution trace indicative of a sequential list of states of the shared hardware component;
initiating a dedicated model hardware component to the initial state, the dedicated model hardware component belonging to a model of the system wherein each functional module is adapted to be executed using a respective dedicated model hardware component and the set of authorized information exchange is represented by a communication unit operatively connected to each of the dedicated model hardware components;
executing the instruction sequence of the functional module using the dedicated model hardware component and the model communication unit while producing a corresponding second execution trace indicative of a sequential list of states of the dedicated model hardware component;
comparing the first and second execution traces, (or comparing a set of first execution traces and a set of second execution traces);
determining that the security condition is satisfied if the first execution trace indicating the observations of the functional modules is equal to the second execution trace indicating the observations of the functional modules; and
generating a security condition satisfaction signal if it is determined that the security condition is satisfied.

In some embodiments, the communication unit may be operatively connected to each of the dedicated model hardware components via a respective security handler representing the security kernel control. Then, the method may further comprise transferring (by the security handler of a dedicated model hardware component of a particular function unit) authorized information from the dedicated model hardware component to the communication unit when execution of the instruction sequence of the particular (sender) functional module is interrupted, and transferring (by the security handler of a dedicated model hardware component of a particular function unit) authorized information to the dedicated model hardware component from the communication unit when execution of the instruction sequence of the particular (receiver) functional module is resumed.

According to some embodiments, the shared hardware component may comprise a memory unit storing memory data related to the first and second functional module. Then, the first and second observable parameters (e.g. the states of the shared hardware component and of the dedicated model components) may be indicative of a corresponding content of the memory unit, and the security condition may comprise a condition that memory data related to the execution of the first functional module is not accessible during execution of the second functional module (and possibly vice versa).

According to some embodiments, the shared hardware component may comprise a processor with a register unit. Then, the first and second observable parameters (e.g. the states of the shared hardware component and of the dedicated model components) may be indicative of a corresponding content of the register unit, and the security condition may comprise a condition that content of the register unit related to the execution of the first functional module is not altered during execution of the second functional module.

According to one example, when a functional module (e.g. A) executes in the shared hardware model it can access the (CPU) registers of the shared hardware (and/or other hardware resources), but when it is suspended the content of its accessible registers is stored in the security kernel. Then, the resumed partition (e.g. B) can also access the CPU registers and alter their content. Thus, it should be made sure that the stored register content related to module A will not be modified by other partitions, here by module B.

Each of the respective dedicated model hardware components may be physically separated and only operatively connected to each other through the communication unit according to some embodiments.

The method may, in some embodiments, further comprise determining that the security condition is not satisfied if (for at least one of the functional modules, initial states, and instructions) the first observable parameter is not equal to the second observable parameter and generating a security condition non-satisfaction signal if it is determined that the security condition is not satisfied.

In some embodiments, determining that the security condition is satisfied may comprise
determining, for each functional module, that the functional module has the same observations in a state of the shared hardware component after execution of bootstrap code of the security kernel and in an initial state of the dedicated model hardware component;
determining, for each instruction and for each functional module, that execution of the instruction by the functional module on the shared hardware component has a corresponding state transition from a corresponding state on the dedicated model hardware component, and that execution of the instruction by the functional module on the shared hardware component and execution of the instruction on the dedicated model hardware component lead to a states that have equal observations; and
determining, for each functional module, that an exception raised in a particular state of the dedicated model hardware component has a corresponding exception of the security kernel for a corresponding state of the shared hardware component, and that observations of the functional module after handling the exception of the dedicated model hardware component are equal to observations of the functional module after handling the corresponding exception of the shared hardware component.

According to some embodiments, verification of a security condition may generate the result “satisfied” or “unsatisfied”.

In some embodiments, it may be verified that, for each initial state, the set of observable traces of each functional module in the shared hardware model is the same as the set of its observable traces in the dedicated hardware.

In some embodiments, the security condition may be symmetric, i.e. the information flow from first to second and also from the second to the first module should be verified/checked.

A second aspect is a computer program product comprising a computer readable medium, having thereon a computer program comprising program instructions, the computer program being loadable into a data-processing unit and adapted to cause execution of the method according to the first aspect when the computer program is run by the data-processing unit.

According to a third aspect, a security condition verification arrangement is provided of a system comprising first and second security domains relating to respective first and second functional modules, a security kernel and a shared hardware component, wherein each of the first and second functional modules is adapted to be executed using the shared hardware component. The security condition comprises a condition that any piece of information, originating from executing a first one of the functional modules and affecting execution of a second one of the functional modules, belongs to a set of authorized information exchange between the first and second security domains (and possibly vice versa), and the security kernel is adapted to control the execution of the first and second functional modules.

The arrangement comprises a determiner and a signal generator. The determiner is adapted to determine that the security condition is satisfied if (for each of the functional modules, for each initial state, and for each instruction) a first observable parameter—associated with execution of the instruction of the functional module under control of the security kernel using the shared hardware component having the initial state—equals a second observable parameter—associated with execution of the instruction of the functional module using a dedicated model hardware component having the initial state. The dedicated model hardware component belongs to a model of the system wherein each functional module is adapted to be executed using a respective dedicated model hardware component and the set of authorized information exchange is represented by a communication unit operatively connected to each of the dedicated model hardware components via a respective security handler representing the security kernel control. The signal generator is adapted to generate a security condition satisfaction signal responsive to the determiner determining that the security condition is satisfied.

In some embodiments, the arrangement may further comprise:
an initiation verifier adapted to determine, for each functional module, whether the functional module has identical observations in a state of the shared hardware component after execution of bootstrap code of the security kernel and in an initial state of the dedicated model hardware component;
an instruction verifier adapted to determine, for each instruction and for each functional module, whether execution of the instruction by the functional module on the shared hardware component has a corresponding state transition from a corresponding state on the dedicated model hardware component, and whether execution of the instruction by the functional module on the shared hardware component and execution of the instruction on the dedicated model hardware component lead to a states that have equal observations; and
a handler verifier adapted to determine, for each functional module, whether an exception raised in a particular state of the dedicated model hardware component has a corresponding exception of the security kernel for a corresponding state of the shared hardware component, and whether observations of the functional module after handling the exception of the dedicated model hardware component are equal to observations of the functional module after handling the corresponding exception of the shared hardware component.

In such embodiments, the determiner may be adapted to determine that the security condition is satisfied responsive to the determinations from the instruction verifier, the initiation verifier and the handler verifier. For example, the security condition may be considered to be satisfied if the determinations from all three verifiers indicate that the respective condition is satisfied.

In some embodiments, the arrangement may comprise a respective dedicated model hardware component for each functional module, a communication unit, a first trace producer, a second trace producer, an initial state selector, an initiator, an execution trace comparator, a determiner, and a signal generator.

The respective dedicated model hardware component is adapted to be used for execution of the functional module, and the communication unit (operatively connected to each of the dedicated model hardware components) is adapted to represent the set of authorized information exchange.

The first trace producer is adapted to produce (during execution under control of the security kernel using the shared hardware component) a corresponding first execution trace indicative of a sequential list of states of the shared hardware component, and the second trace producer is adapted to produce (during execution using the dedicated model hardware components and the model communication unit) a corresponding second execution trace indicative of a sequential list of states of the dedicated model hardware components.

The initial state selector is adapted to select, for each functional module, an initial state of the functional module. The initiator is adapted to initiate the dedicated respective hardware components and the shared hardware component to the selected initial states, cause execution of each of a set of instruction sequences for the functional module using the shared hardware component under control of the security kernel, and cause execution of each of a set of instruction sequences for the functional module using the dedicated model hardware components and the model communication unit.

The execution trace comparator is adapted to compare the first and second execution traces, the determiner of these embodiments is adapted to determine that the security condition is satisfied responsive to the comparator indicating that the first execution trace is equal to the second execution trace, and the signal generator of these embodiments is adapted to generate a security condition satisfaction signal responsive to the determiner determining that the security condition is satisfied.

In some embodiments, the arrangement of the third aspect may further comprise the first and second functional modules, the security kernel and the shared hardware component.

A fourth aspect is an electronic device comprising the arrangement according to the third aspect.

In some embodiments, the third and fourth aspects may additionally have features identical with or corresponding to any of the various features as explained above for the first aspect.

An advantage of some embodiments is that verification of a security kernel is enabled.

Another advantage of some embodiments is communication between the functional modules is taken into account in the verification process.

### BRIEF DESCRIPTION OF THE DRAWINGS

Further objects, features and advantages will appear from the following detailed description of embodiments, with reference being made to the accompanying drawings, in which:

FIG. 1 is a schematic block diagram illustrating an example situation according to some embodiments;

FIG. 2 is a schematic block diagram illustrating three example situations according to some embodiments;

FIG. 3 is a schematic block diagram illustrating an example situation according to some embodiments;

FIG. 4A is a flowchart illustrating example method steps according to some embodiments;

FIG. 4B is a flowchart illustrating example method steps according to some embodiments;

FIG. 4C is a flowchart illustrating example method steps according to some embodiments;

FIG. 5 is a schematic block diagram illustrating an example ideal model according to some embodiments;

FIG. 6 is a schematic block diagram illustrating an example ideal model according to some embodiments;

FIG. 7 is a schematic state transition diagram illustrating an example verification approach according to some embodiments;

FIG. 8 is a schematic state transition diagram illustrating an example verification approach via two state transition diagrams according to some embodiments;

FIG. 9 is a schematic block diagram illustrating an example collection of shared hardware components according to some embodiments;

FIG. 10 is a schematic block diagram illustrating an example system set-up according to some embodiments;

FIG. 11 is a schematic block diagram illustrating an example arrangement according to some embodiments;

FIG. 12 is a schematic block diagram illustrating an example arrangement according to some embodiments; and

FIG. 13 is a schematic drawing illustrating a computer readable medium arrangement according to some embodiments.

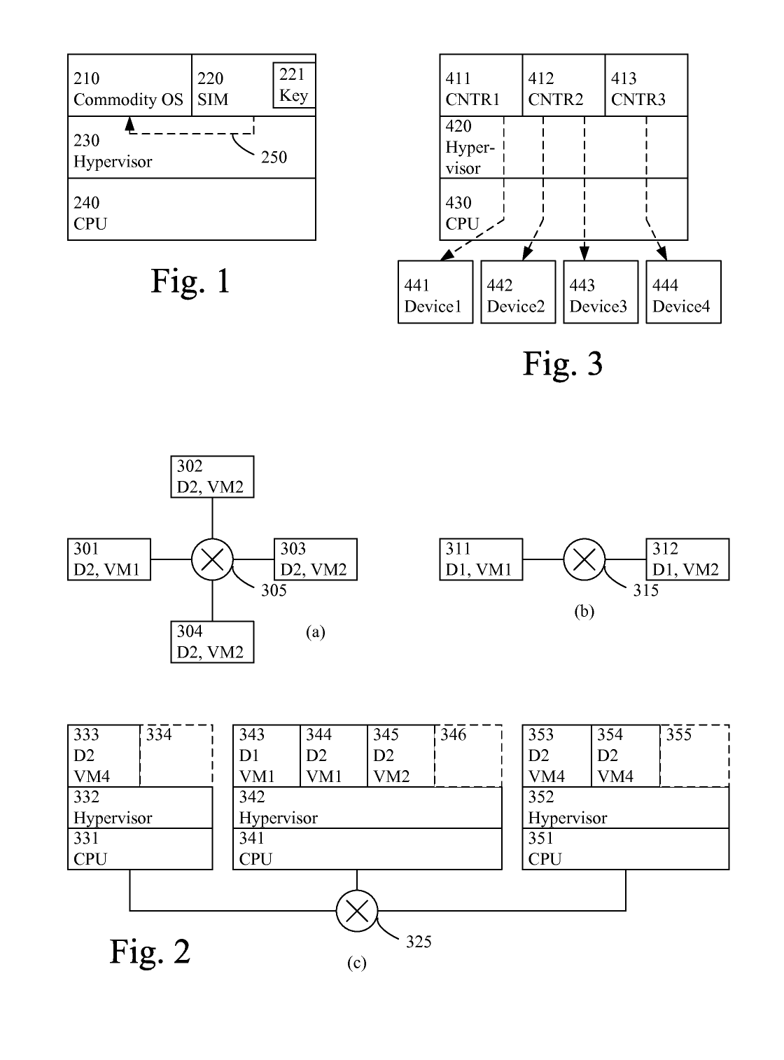

### DETAILED DESCRIPTION

In the following, some examples will be presented according to various embodiments. These examples are presented for illustrative purposes and are not to be construed as limiting. For example, features of some embodiments may be combined with features of other embodiments even though the combination has not been explicitly disclosed. Furthermore, features of some embodiments may be excluded even though the exclusion has not been explicitly disclosed.

A hypervisor is typically a piece of software which allows several partitions to share available hardware resources. Although a hypervisor is intended to allow the partitions to execute in isolation, it should beneficially be verified that it really does so and provides isolation for the partitions. According to some embodiments herein, the hypervisor does not do any verification, monitoring or property enforcement at runtime and the verification may be performed statically. According to some embodiments, the hypervisor may have some services to do verification at runtime.

Security verification of a hypervisor (kernel) is typically not a trivial task. An objective of the kernel may be to make it appear that each of the component systems (functional modules of different security domains) is executed on a separate (isolated) machine (a partition) and to ensure that communication can only flow as authorized along known external channels between the partitions. Moreover, a separation kernel design should typically work uniformly for all component systems.

One problem that arises when delegating communication in a model to an external agent is that potential side channels are ignored. Any arbitrary message can encode as much information as its entropy, but in addition there is also information carried by associated side channels (e.g. timing, energy, space). Communication and non-interference among partitions are in conflict. In fact, any communication may convey critical information (e.g. timing information) that an attacker can exploit to extract secret information.

In the following, embodiments will be described where security verification of a hypervisor (security kernel) is enabled and wherein communication between partitions is included in the verification model.

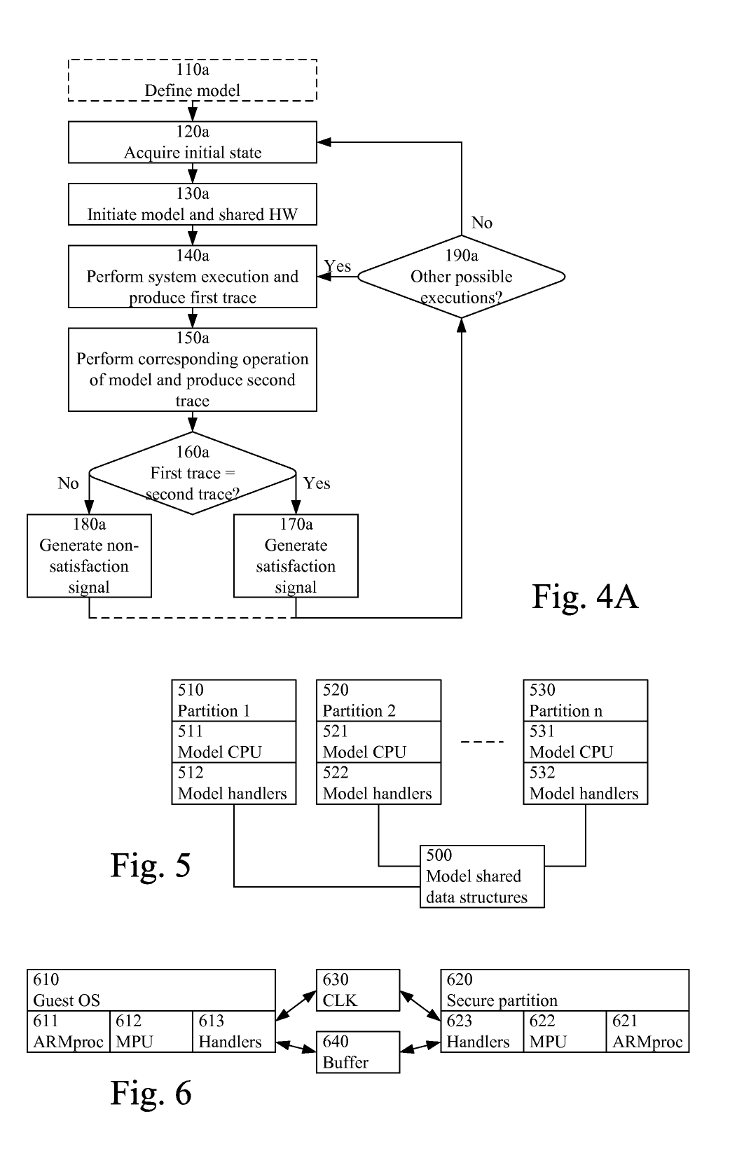

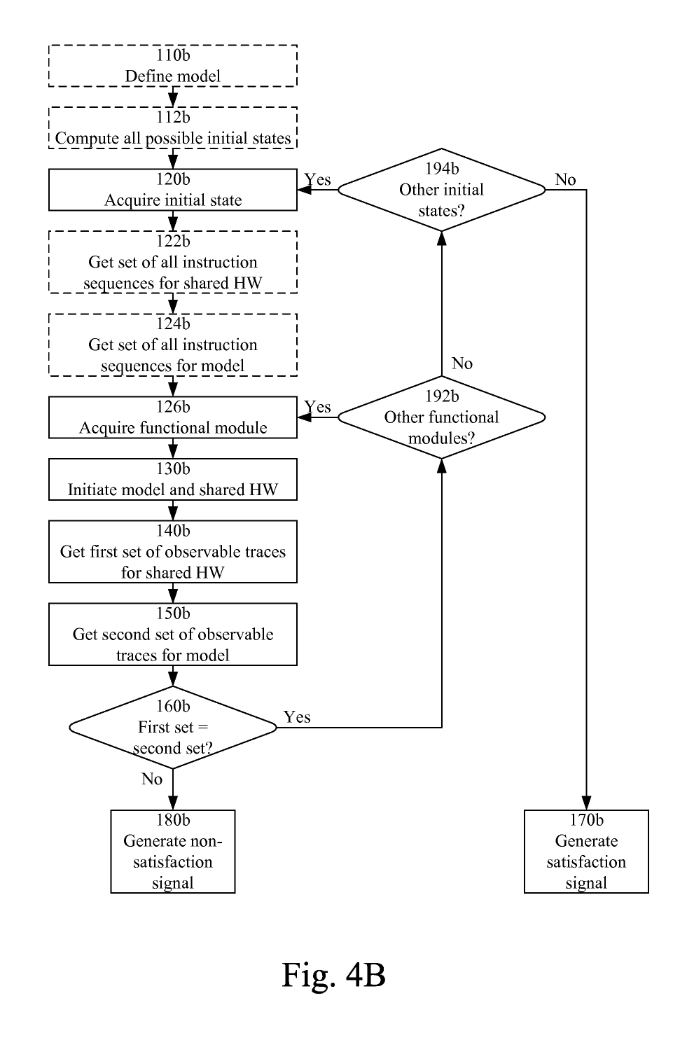

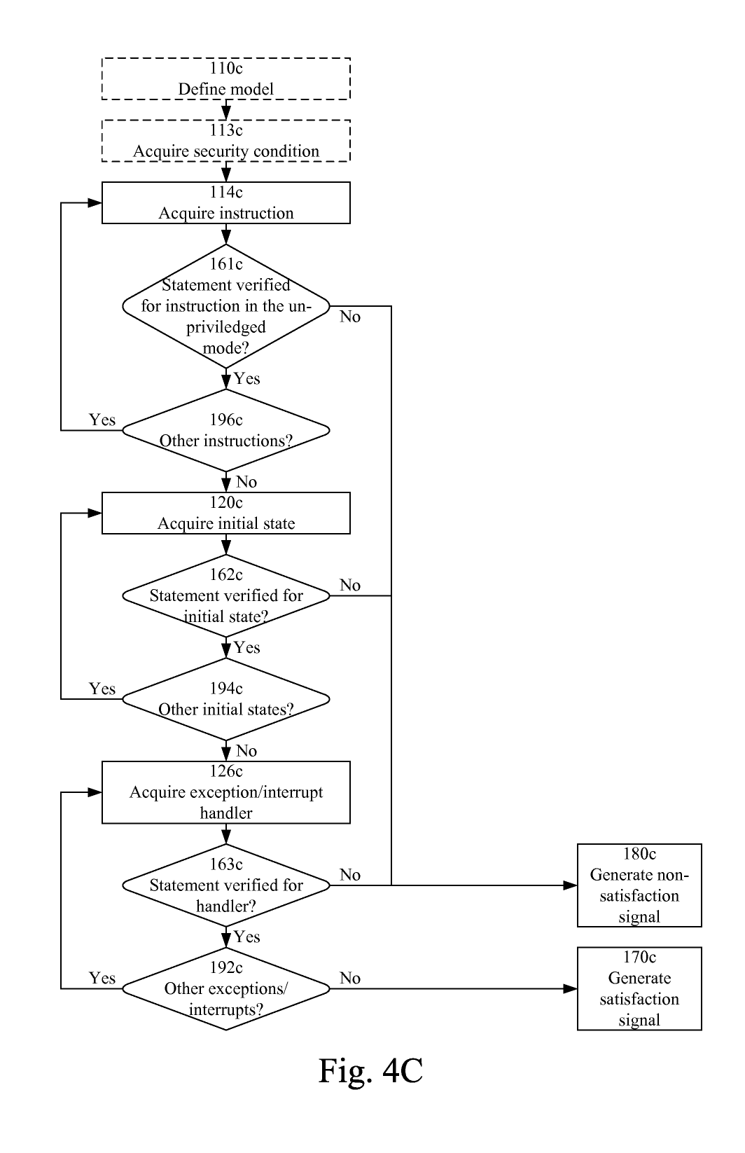

According to some embodiments, the verification is not done at runtime (during execution) by the hypervisor, i.e. hypervisor is not responsible for performing the verification in these embodiments. One aim of a hypervisor is typically to provide isolation, and it is typically beneficial to verify that the hypervisor actually provides the isolation it should. In some embodiments, the code of the hypervisor is verified statically (once) and the verification holds as long as the kernel code is not altered. FIG. 4A illustrates example method steps according to some embodiments.

The method starts in step 110a, where an ideal model is defined of a system comprising at least two (e.g. first and second) security domains relating to respective (e.g. first and second) functional modules executing using a shared hardware component (which may comprise one or more shared hardware components) under control of a security kernel. The security condition may, for example, comprise a condition that any piece of information (originating from executing a first one of the functional modules and affecting execution of a second one of the functional modules) belongs to a set of authorized information exchange between the first and second security domains.

The ideal model comprises a dedicated model hardware component for each of the functional modules, wherein the dedicated model hardware components of different functional components are physically separated and only operatively connected to each other through a communication unit representing the set of authorized information exchange.

The communication unit may, for example, be operatively connected to each of the dedicated model hardware components via a respective security handler representing the security kernel control. A security handler for a particular functional unit may transfer authorized information from the dedicated model hardware component to the communication unit when execution of the instruction sequence of the particular functional module is interrupted and transfer authorized information to the dedicated model hardware component from the communication unit when execution of the instruction sequence of the particular functional module is resumed.

Example types of authorized communication modeled by the communication unit include asynchronous messages and communication via a shared memory. In the case of authorized communication via a shared memory, some part of the memory may be write accessible for one functional module and read accessible to another functional module and thereby communication between the modules may occur through this part of the memory.

The ideal model will also be referred to herein as a top level specification (TLS). FIGS. 5 and 6 illustrate two example ideal models that may be applied in step 110a according to some embodiments.

In the ideal model of FIG. 5, n different functional modules are executed in isolated partitions (1, 2, . . . , n) 510, 520, 530 using respective dedicated model hardware (Model CPU) 511, 521, 531. The partitions are connected to each other through a communication unit (model shared data structures) 500 via respective security handlers (model handlers) 512, 522, 532.

In the ideal model of FIG. 6, two different functional modules (a guest/client OS and a secure function such as a SIM application) are executed in isolated partitions (guest OS and secure partition, respectively) 610, 620 using respective dedicated model hardware, in this case an ARM processor (ARMproc) 611, 621 and a memory protection unit (MPU, which may be responsible for controlling memory accesses) 612, 622. The partitions are connected to each other through a communication unit such as a message buffer 640 via respective security handlers 613, 623. A system clock (CLK) 630 is also provided to simulate the operation cycles of the actual system.

Step 110a of FIG. 4A may, for example, be performed by an apparatus or device or by a user of the method or by a combination thereof. In some embodiments, the ideal model is pre-defined and the method commences in step 120a.

In step 120a, an initial state is acquired. This may for example be by a user entering an initial state, by a selector (external or internal to the model) selecting an initial state, by receiving a signal indicative of an initial state, by retreating an initial state form the shared hardware component, or by any other suitable way. Typically, an initial state is acquired for each of the functional modules and each of the functional modules is verified as follows.

The initial state is used to initiate the dedicated hardware components of the ideal model (and typically also the shared hardware components if not already initiated) in step 130a.

Then, steps 140a and 150a are performed in the order shown in FIG. 4A, in opposite order or (substantially) in parallel. Step 140a relates to execution of one or more possible instructions of the functional module using the shared hardware components under control of the security kernel and the production of a corresponding execution trace which indicates the state changes of the shared hardware during the execution. Step 150a relates to execution of the same one or more possible instructions of the functional module using the dedicated hardware components of the ideal model and the production of a corresponding execution trace which indicates the state changes of the dedicated hardware during the execution.

The two traces are compared in step 160a and if the traces are equal (Yes-path out from step 160a) it is determined that the security condition is satisfied and a security condition satisfaction signal is generated in step 170a. If the traces are not equal (No-path out from step 160a) it is determined that the security condition is not satisfied and a security condition non-satisfaction signal is generated in step 180a.

Steps 140a, 150a, 160a, 170a and 180a may be performed for several sequences of one or more possible instructions as indicated by the Yes-path out of step 190a. The method may be repeated for more initial states as indicated by the No-path out of step 190a. Furthermore, the method may be repeated for several functional modules (not shown).

If a non-satisfaction signal is generated in step 180a, the security (isolation) condition is not satisfied (i.e. the kernel code is not correct). The method may be terminated or continued as indicated by the dashed line out of step 180a.

If a satisfaction signal is generated in step 170a, the security (isolation) condition is satisfied with regard to that particular choice of initial state, instruction(s) and functional module. In some embodiments, a satisfaction signal (similar to that of step 170a) is only generated if all iterations with different choices of initial state, instruction(s) and functional module indicate that the traces are equal (Yes-path out from step 160a).

FIG. 4B shows an abstraction of an example verification method (compare also with FIG. 4A).

Step 110b is similar to step 110a of FIG. 4A and will not be elaborated on further. In step 112b, all initial states to be part of the verification (e.g. all possible initial states or a subset thereof) are computed and in step 120b one of the initial states is acquired (compare with step 120a of FIG. 4A).

In step 122b and 124b, the set of all possible instruction sequences (instruction traces) for the acquired initial state is acquired for the shared hardware and for the model, respectively.

Then a functional module is selected in step 126b, and the model and the shared hardware are initiated in step 130b (compare with step 130a of FIG. 4A).

In steps 140b and 150b (compare with steps 140a and 150a of FIG. 4A), sets of observable parameters (traces) are provided for the shared hardware and for the model, respectively. The sets of observable parameters of steps 140b and 150b relate to the acquired initial state (step 120b) and the acquired functional module (step 126b) and correspond to respective ones of the sets of instruction sequences of steps 122b and 124b, respectively.

The result of step 140b is compared to that of step 150b in step 160b, and if there is a difference between them (No-path out of step 160b) a non-satisfaction signal is generated in step 180b (compare with step 180a of FIG. 4A).

The comparison of step 160b may be repeated for several (e.g. all) functional modules as indicated by step 192b and for several (e.g. all) initial states as indicated by step 194b. If all comparisons in step 160b indicate that the observable parameters (traces) are identical, a satisfaction signal is generated in step 170b.

The methods of FIGS. 4A and/or 4B may be cumbersome to implement, and an alternative method is presented in FIG. 4C, which will be described in further detail later in this disclosure.

FIG. 7 illustrate one methodology that may be applied when verifying the security condition. This approach is commonly termed as bi-simulation and relates to correlating each transition between states of a system (e.g. the shared hardware component) with a corresponding transition between states of a model of the system. The items 720 and 740 denotes two different states of the system and 780 denotes a transition from state 720 to state 740 while items 710 and 730 denotes two different states of the model system and 770 denotes a transition from state 710 to state 730. If the system fulfills the conditions used to set up the model, state 720 should correspond to state 710 and state 740 should correspond to state 730 according to this approach as indicated by the dashed lines 750 and 760 respectively.

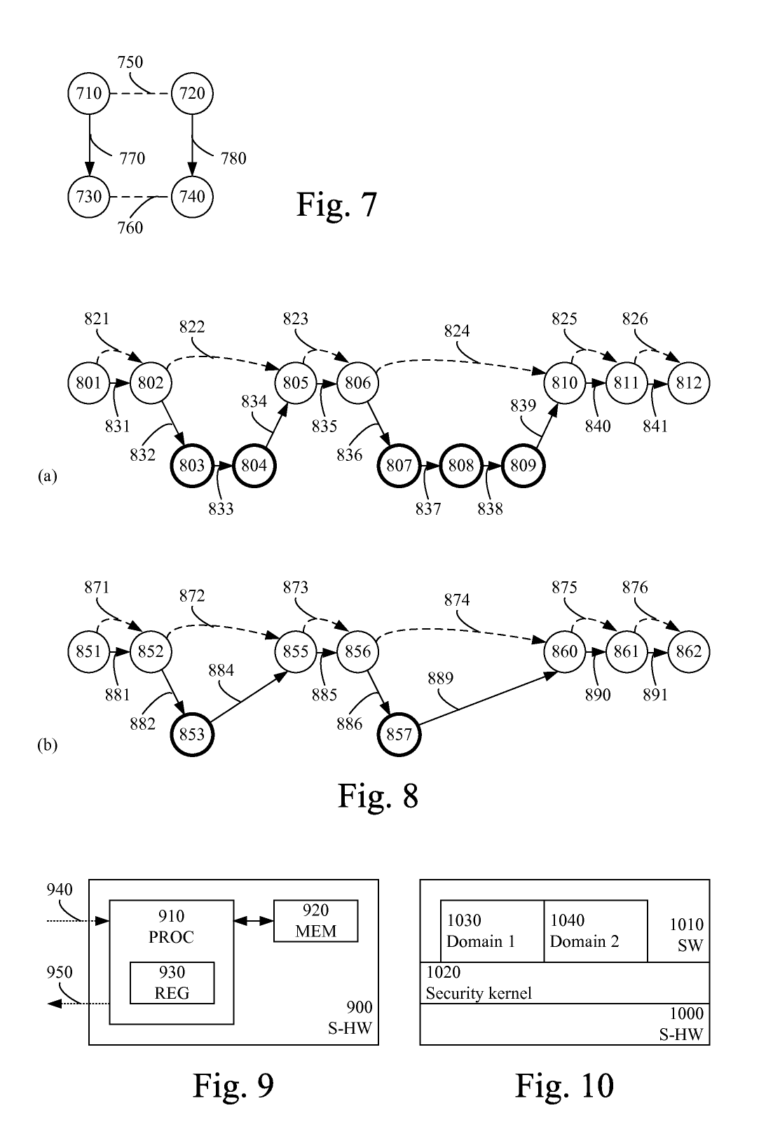

FIG. 8 schematically illustrates the application of bi-simulation to the execution of a sequence of instructions of a functional unit starting from an initial state. Part (a) of FIG. 8 illustrates execution using the shared hardware components and part (b) illustrates the corresponding execution using the ideal model. The executions start in a corresponding initial state (801, 851).

In part (a), the upper states 801, 802, 805, 806, 810, 811, 812 (represented by thin line circles) correspond to execution in a low privileged mode of the shared hardware, which typically corresponds to the execution of a functional module. The lower states 803, 804, 807, 808, 809 (represented by thick line circles) correspond to execution in a high privileged mode of the shared hardware, which typically corresponds to the execution of the security kernel. There are four types of state transitions shown in relation to part (a) of FIG. 8; transitions between states in the low privileged mode (831, 835, 840, 841), transitions from the low privileged mode to the high privileged mode (832, 836) which are typically due to an event generated interruption signal or a scheduled interruption signal, transitions between states of the high privileged mode (833, 837, 838), and transitions from the high privileged mode to the low privileged mode (834, 839) which may be due to the kernel scheduling execution of the functional module. Switching from privileged mode to user mode is usually done after handling an exception/interrupt. The interrupt can be a scheduling signal, but it can also be other interrupts or exceptions.

In part (b), the upper states 851, 852, 855, 856, 860, 861, 862 (represented by thin line circles) correspond to execution of a functional module using the corresponding dedicated hardware. The lower states 853, 857 (represented by thick line circles) correspond to invocation of the security handle of the functional module and corresponding interaction with the communication unit. There are three types of state transitions shown in relation to part (b) of FIG. 8; transitions between states in the low privileged mode (881, 885, 890, 891), transitions from the low privileged mode to the high privileged mode (882, 886), and transitions from the high privileged mode to the low privileged mode (884, 889).

The execution in part (a) generates a trace 821, 822, 823, 824, 825, 826 indicative of the following sequence of states: 801, 802, 805, 806, 810, 811, 812. The execution in part (b) generates a trace 871, 872, 873, 874, 875, 876 indicative of the following sequence of states: 851, 852, 855, 856, 860, 861, 862. If the traces coincide, it may be concluded that the system fulfills the conditions used to set up the model for this particular functional module, initial state and sequence of instructions.

FIG. 9 illustrates an example collection of shared hardware components 900 according to some embodiments. The shared hardware components may comprise, for example, one or more processors (PROC) 910 with one or more respective register units (REG) 930 and one or more memory units (MEM) 920. The processor(s) 910 may be operatively connected to the memory unit(s) 920 and may have one or more input ports 940 and/or one or more output ports 950.

The memory unit may store memory data related to the functional modules, and the states of the shared hardware component (and of the dedicated model components) may be indicative of a corresponding content of the memory unit. In such cases, the security condition may comprise a condition that memory data related to the execution of the first functional module is not accessible during execution of the second functional module (and possibly vice versa).

Alternatively or additionally, the states of the shared hardware component (and of the dedicated model components) may be indicative of a content of the register unit(s), and the security condition may comprise a condition that content of the register unit related to the execution of the first functional module is not altered during execution of the second functional module.

Yet alternatively or additionally, the states of the shared hardware component (and of the dedicated model components) may be indicative of values of processor parameters such as, for example, values of the input and/or output ports, operational modes, etc.

FIG. 10 schematically illustrates an example system set-up according to some embodiments showing a shared hardware component (S-HW) 1000 and a software component (SW) 1010 executing on the shared hardware component. The software component 1010 comprises two functional modules operating in a respective security domain (domain 1 and domain 2) 1030, 1040 under control of a security kernel 1020.

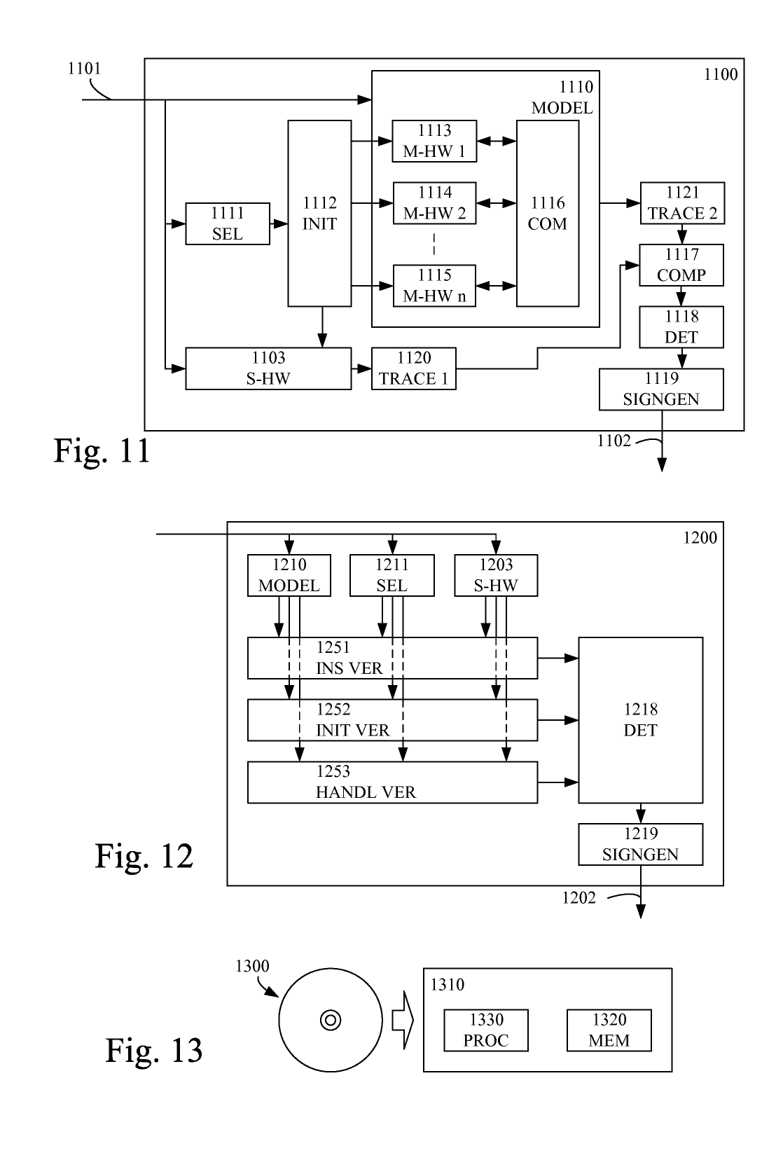

FIG. 11 schematically illustrates an example arrangement 1100 according to some embodiments. The arrangement 1100 may, for example, be adapted to perform one or more of the method steps as described in connection with FIGS. 4A and/or 4B. The arrangement 1100 may, for example, be comprised in an electronic device.

The arrangement 1100 may be used for verification of one or more security conditions of a system (compare with the system of FIG. 10) comprising two or more security domains relating to respective functional modules, a security kernel and one or more shared hardware components. Each of the functional modules is adapted to be executed using the shared hardware components and the security kernel is adapted to control the execution of the functional modules. An example security condition comprises a condition that models the isolation prerequisite that any piece of information, originating from execution of one of the functional modules and affecting execution of another of the functional modules, belongs to a set of authorized information exchange between the corresponding security domains. The system to be verified may or may not be comprised in the security condition verification arrangement. In the example of FIG. 11, the shared hardware components (S-HW) 1103 are illustrated as comprised in the arrangement. In some embodiments, the block 1103 may be related to the shared hardware (without comprising the actual shared hardware), e.g. it may be a representation of how the security kernel and the functional modules operate on the shared hardware.

In this example, the arrangement 1100 comprises an ideal model 1110 representing the execution using the shared hardware components by a corresponding execution using dedicated hardware components. In the model 1110, each functional module (in this case n functional modules) is assigned a respective dedicated model hardware blocks (M-HW 1, M-HW 2, . . . , M-HW n) 1113, 1114, 1115, each comprising one or more dedicated model hardware components, to be used for execution of the respective functional module. Typically, each of the dedicated model hardware blocks 1113, 1114, 1115 correspond to the shared hardware 1103. The model 1110 also comprises a communication unit (COM) 1116 operatively connected to each of the dedicated model hardware blocks and adapted to represent the set of authorized information exchange between security domains. In some embodiments, the block 1110 may be related to the dedicated model hardware blocks and the communication unit (without comprising the actual dedicated model hardware blocks and communication unit), e.g. it may be a representation of how the model would operate under execution.

The arrangement 1100 also comprises first and second trace producers (TRACE 1, TRACE 2) 1120, 1121. The first trace producer 1120 produces a first execution trace indicative of a sequential list of states of the shared hardware 1103 during execution under control of the security kernel, and the second trace producer 1121 produces a second execution trace indicative of a sequential list of states of the dedicated model hardware during execution using the model 1110.

The first and second traces may be generated for each functional module, for one or more initial states and for one or more instructions or instruction sequences. For this purpose, the arrangement also comprises an initial state selector (SEL) 1111 to select an initial state for each functional module and an initiator (INIT) 1112. The initiator initiate the dedicated model hardware 1113, 1114, 1115 and the shared hardware 1103 to the selected initial states and causes execution of the same relevant instruction(s) using the shared hardware 1103 and the model 1110.

When the first and second traces have been produced (for at least one functional module, at least one initial state and at least one instruction) an execution trace comparator (COMP) 1117 compares the first and second execution traces, and a determiner (DET) 1118 determines that the security condition is satisfied (for the functional module, initial state and instruction(s)) if the first execution trace is equal to the second execution trace and that the security condition is not satisfied if the first execution trace is not equal to the second execution trace. A signal generator (SIGNGEN) 1119 correspondingly generates a security condition verification or non-satisfaction signal 1102. The signal 1102 may, for example, be transmitted to another electronic device using a transmitter or transferred to another component of the same electronic device. In one example, the signal 1102 is used by a rendering unit of an electronic device to convey information indicative of the result of the security condition verification to a user of the arrangement 1100 through an output interface of an electronic device (e.g. the same electronic device comprising the arrangement 1100 or the electronic device from which the input signals are received).

In the example of FIG. 11, the arrangement 1100 is provided with an input port 1101 for receiving input signals. The input signals may, for example, be received from another electronic device using a receiver or transferred from another component of the same electronic device. In one example, the input signals are supplied by a user of the arrangement 1100 through an input interface of an electronic device (e.g. the same electronic device comprising the arrangement 1100 or the electronic device from which the input signals are received). The input signals may, for example, be indicative of one or more of parameters of the model 1110, a function module to evaluate, and one or more instruction (sequences) to evaluate.

Thus, according to some embodiments, a method for formal security kernel verification has been provided and can be demonstrated on a concrete kernel executing on real hardware. An example embodiment will now be described in further detail.

The isolation properties of a security kernel can be specified using a Top Level Specification (TLS). One challenge in providing such a TLS is to accurately reflect all potential direct and indirect communication channels available to a partition (security domain) while it is in control of one or more of the processor cores (and/or any other shared hardware components), while being abstract enough to allow for variability in the design of the kernel itself and its functionality. The notations processor core and core will be used interchangeably herein.

According to some embodiments, a Top Level Specification (TLS) is used that associates a kernel implementation on a shared physical processor (and/or any other shared hardware components) to a physically distributed model implementation (also called ideal system or ideal model herein) in which each partition executes on top of a physically separated model processor (and/or any other model hardware components), and communicates using only model communication channels (represented by security handlers of the partitions and a communication unit), wherein the model communication channels serve to represent the actual communication channels that are intended to be supported by the kernel (a set of authorized information exchange). An example TLS for a single core processor is shown in FIG. 5.

Each partition may, for example, represent the memory and register states of a shared processor core when the partition is in control of the execution, and the corresponding model processor core may represent the actions of the shared processor core when the partition is in control. The security kernel may be invoked when the core transitions into a privileged mode based on the occurrence of, for example, some internal error condition, some internal signal, a specific mode changing instruction, or an interrupt generated by some external event. Invocation of the kernel may be modeled by a collection of model handlers that describe (predicate) how the separation kernel should react to a privileged mode transition, e.g. in terms of changes to the observable state of each of the partitions. According to some embodiments, the modeling of the kernel invocation may require access to external model representations of the state of the processor core or to external devices (e.g. timers, storage, networks, and/or other peripherals).

The same or a similar TLS approach may apply to situations with a multi-core system. However, for some multi-core systems one partition may be in control of several CPU cores at the same time, which should also be taken into account in the model.

Thus, using the disclosed approach, it is possible to model the desired isolation properties of a security kernel using a Top Level Specification. Moreover, it is possible to devise effective means to verify that a security kernel satisfies the Top Level Specification.

The verification may, for example, be performed by exhibiting a bi-simulation relation R (compare with the dashed lines 750 and 760 of FIG. 7) showing that each state of the TLS model (including e.g. the state of each partition including its model processor, and the state of the shared mode data represented by the communication unit) can be related to a corresponding system state (including e.g. the state of the shared processor cores, the partition states, and the security kernel states), such that the observable properties of each partition are preserved in both directions (the observation of each partition is identical in the real and ideal models).

The observations in relation to either or both of the model state and the system state may be the memory and register assignments applying to each active partition (partition that is scheduled for execution at that state). The observations apply to a model state may be considered preserved if and only if the same observations apply to any related system state.

In general, the observation of a partition may comprise those parts of the system state (either shared hardware or dedicated hardware) that are observable by a partition, e.g. a region of memory, some registers, etc. In some embodiments, it is checked that the observation of each partition in the real system is same as its observation in the ideal system.

Two different types of state transitions (compare with FIGS. 7 and 8) include state transitions that do not involve a transition into privileged mode of the system, e.g. transitions 831 and 835, (no invocation of a model handler for the model, e.g. transitions 881 and 885) and state transitions that do involve a transition into privileged mode of the system, e.g. transitions 832 and 836, (invocation of a model handler for the model, e.g. transitions 882 and 886).

According to some embodiments, the verification process comprises an assumption that a model state transition and the corresponding system state transition are of the same type. Furthermore, the verification process may comprise an assumption that a system state transition and the corresponding model state transition are of the same type. Yet further, the verification process may comprise an assumption regarding correct initialization of the system. The verification may comprise verifying that these assumptions hold.

The verification proof may be split into two cases relating to the two types of transitions. The verification for the first case, where the state transition of the system does not involve a change to privileged mode, is only dependent on processor generic properties and independent of the kernel code. Thus, the verification of this first case may be given a generic (kernel independent) proof, e.g. using a theorem prover such as Coq or High Order Logic (HOL). The verification of the first case will be elaborated on further below. The verification for the second case, where the state transition of the system involves a mode change, reduces to a proof of that the security kernel handler code on the shared hardware accurately implements the model handlers. This can, to a large extent, be proved automatically, e.g. using a code verification tool such as a Binary Analysis Platform (BAP), which is able to perform weakest pre-condition calculations and/or strongest post-condition calculations.

Thus, some embodiments comprise a method for specifying isolation properties of a security kernel based on the approach of comparing the execution of security partitions on shared hardware with the execution of partitions on physically separated model hardware, and some embodiments comprise a verification process which splits the proof of isolation for a concrete processor architecture in a processor specific, but kernel independent, part and a part verifiable using largely automated tools relying on the actual kernel code.

Isolation properties may, for example, comprise fulfilling a condition that no un-authorized interaction (information exchange) between the security domains is present. Authorized interaction (information exchange) may be specified by one or more authorization rules (e.g. stored in a memory and used by a shared data structure handler to model the isolation properties). The authorization rules may, for example, define one or more of: how data of one security domain may be accessed by another security domain; how a current state of one security domain may affect the state and/or data of another security domain; how data and/or state(s) of one security domain should be loaded before execution associated with the security domain is commenced; and how data and/or state(s) of one security domain should be archived before loading of data and/or state(s) and execution associated with another security domain is commenced. Data and states of the security domains may be physically stored in one or more memory units of the shared hardware resources.

As elaborated on above, the verification of a kernel may be based on the introduction of a Top Level Specification (TLS). The TLS provides separated environments (partitions, security domains) for execution of the critical components (functional modules), thus formalizing a system that is secure by construction. In some embodiments, the kernel is considered secure if the observable traces of the TLS (if properly set up, of course) are the same as the observable traces of the actual system, wherein the observable traces of the actual system are obtained by executing the components (functional modules) in different partitions (security domains) on top of the kernel on the shared processor (and/or other shared hardware components). This may be verified using observation-based bi-simulation (see e.g. D. Sangiorgi, “Introduction to Bisimulation and Coinduction”, Cambridge University Press, 2012) as a suitable unwinding condition.

Typically, a detailed model of the system that hosts the kernel and the guests (functional modules) is formalized (e.g. using a theorem assistant software like HOL4) in order to enable the verification. According to these approaches, a system state s ∈ S contains all processor information (e.g. registers, coprocessors, and the like), the system memory and the device states. In some embodiments, the hosting environment support different execution modes M representing different privilege levels (e.g. high and low privileged modes). In the following examples, usr ∈ M is used to represent a non-privileged (or low privileged) mode exploited to execute functional modules (guests), while all other modes M ≠ usr are used to execute the kernel activities. The function Mode: s→M is used to represent the current executing mode of a machine state. Functional module activities are executed only in mode usr, while the privileged modes are used to execute the kernel. In the following we use the notation “real system” to refer to the system that executes the kernel and the overlying guests.

The behavior of the system is defined by the state transition relation →∈ S×S. Usually, the CPU prevents explicit change the part of the state that identifies the execution mode while the state is in mode usr, and switching from an unprivileged execution mode to a privileged one depends on the CPU exception mechanism. When an exception occurs, the control of the CPU is transferred to the corresponding interrupt handler and part of the CPU state is backed up, some exceptions are masked, the corresponding privileged execution mode is activated and the program counter is changed to jump to a predefined address in the memory called the vector table.

Part (a) in FIG. 8 depicts an example computation of a real system. Circles with thin and thick lines represent states in user mode and privileged modes, respectively. Transitions between two states in user mode (e.g. 831) do not cause exceptions while transitions between a user mode state and a privileged mode state (e.g. 832) represent reception of an interrupt or an exception and the subsequent activation of the kernel. Transitions that start from a privileged mode state (e.g. 833) represent kernel activities, and transitions from privileged mode states to user mode state (e.g. 834) are caused by instructions that explicitly change the execution mode (these instructions are allowed only in the privileged modes).

The ideal system model formalizes the top level specification and provides a physically separated environment to host each of the software components (functional modules). The ideal system state is modeled by a tuple, d= [symbol] s₁, . . , sₙ, dev, idx [symbol] ∈ Δ. It is composed of several physically separated machines sᵢ ∈ S communicating via external devices. The dev component (corresponding to the communication unit) is used to model communication channels (e.g. comprising a distinct message box for each machine) and external peripherals. Each machine of the ideal system is used to execute one of the system guests. The kernel is not deployed on these machines. The idx component is used for scheduling the functional modules. For example, in the TLS for kernels running on a single core real system idx ∈ [1 . . . n] identifies the active machine and is used to provide an interleaved execution.

The behavior of the ideal system is defined by the state transition relation →⊆Δ×Δ. The approach to allow the execution of functional modules without the run-time support of the kernel is implemented through the ideal machines exploiting special processors (handlers) that intercept all mode-switches to mimic that whenever the real CPU switches to a privileged mode, a kernel functionality is atomically activated.

In the following transition rules of a TLS for kernels targeting single processor core systems will be given as well as rules for the corresponding ideal system having the first machine active. The rules for the other cases may be defined analogously.

While the processor is in user mode, the execution of an instruction in the ideal model behaves equivalently as on a standard CPU, without affecting the state of the non-active machines:

$$\frac{Mode ( {s}_{j} ) = usr {s}_{j} -> {s}_{j}^{′}}{〈 {s}_{1} , … , {s}_{j} , … , {s}_{n} , dev , j 〉 -> 〈 {s}_{1} , … , {s}_{j}^{′} , … , {s}_{n} , dev , j 〉}$$

Whenever the CPU switches to a privileged mode, the ideal system automatically applies a functionality corresponding to kernel activity. The function HYₘ:Δ→Δ represents a deterministic transformation applied to any ideal state with the active guest system state in non-user mode and modeling the intended behavior of the ideal system when the privileged mode m is activated. These transformation functions always yield a state in user mode, i.e., for all m, δ, if HYₘ(δ)= [symbol] s₁, . . . , sₙ, dev, idx [symbol] , then for all j, Mode (sⱼ)=usr. Thus, the following transition rule applies:

$$\frac{Mode ( {s}_{j} ) \neq usr}{〈 {s}_{1} , … , {s}_{n} , dev , j 〉 -> {HY}_{m} ( 〈 {s}_{1} , … , {s}_{n} , dev , j 〉 )}$$

Part (b) in FIG. 8 depicts an example computation of an ideal system. Circles with thin and thick lines represent states in user mode and privileged modes, respectively. The circles 851, 852, 855, 856 represent ideal states wherein the first machine is active. In the states 852, 856, the system traps an exception raised on the active machine and atomically applies the corresponding ideal kernel-like functionality.

Let g be a functional module and let G_{g} be the corresponding initial guest memory, an assignment of values to a subset of the available memory locations. The functions link^{r}(G₁, . . . , Gₙ) ∈ S and linkⁱ(G₁, . . . , Gₙ) ∈ Δ represent the initial real and ideal states yielded by the linkers and deployed on the two systems. Since the kernel is not executed in the ideal model, the function linkⁱ (G₁, . . . , Gₙ) models the setups the initial state: it copies each initial guest memory into the corresponding physical machine memory, it sets up the program counters and status registers of both machines, and it initializes the memory management units (MMU) and device states. The function linkⁱ(G₁, . . . , Gₙ) typically also ensures that all machines of the top level specification are in user mode. Powering on the real system prepares the execution of the kernel boot code. The function link^{r}(G₁, . . . , Gₙ) models the initialization of the memory with the initial guest memories and the kernel binary code. Moreover, it models the activation of the boot code by initializing the program counter and the special purpose registers.

To prove that the real model does not introduce information channels that are not present in the ideal model it suffices to show that the observable traces for each guest (functional module) are the same in both cases (ideal and real). A definition is needed of when each guest system is in control of the system, and what its observations are.

We use Actᵢ(δ, g) and Actᵣ(s, g) to represent two predicates that hold if the guest g is in control of the ideal, δ, and the real, s, states, respectively. Identifying if the guest g is in control of the ideal system is straightforward, Actᵢ( [symbol] s₁, . . . , sₙ, dev, idx [symbol] , g)=(idx=g ∧ s_{g}=usr). In general, identifying if a guest is in control of the real system depends on the scheduler data structures.

The resources of a state that can be observed by the guest constitute the guest state u ∈ U. A guest state can contain the user registers and the memory allocated to the guest. The mask functions O_{g}^{r}:S→U and O_{g}ⁱ:Δ→U model the observation of the guest g in the real and ideal settings, respectively. For the ideal model, it is assumed that the observation of the guest g depends only on the machine s_{g} and the state of the devices. This constraint reflects the intuition that the guests are physically separated. The definition of an ideal mask function is usually straightforward, since the guest can observe a subset of the information held by its dedicated ideal machine. On the other hand, the definition of the corresponding real mask depends on the kernel data structures. In fact, while a guest is not running, part of its state (e.g. the user register) is typically temporally stored into the kernel memory.

Consider now a real execution: π=s₀→s₁→ . . . →sₙ→ . . . . The g-trace of the real execution is the sequence ωᵣ(π, g) of observations obtained by first projecting out those states for which g is not in control, and secondly extracting the observations of g, in other words: ωᵣ(π, g)=MP(O_{g}^{r}, Π(π, Act_{g}^{r})). Similarly, if π is an ideal execution, the corresponding g-trace is ωᵢ(π, g)=MP (O_{g}ⁱ, Π(π, Act_{g}ⁱ)). The projection Π and the map MP functions may be defined according to any suitable known or future method.

Let πᵣ(G₁, . . . , Gₙ) be an execution of the real system starting from the initial state link^{r}(G₁, . . . , Gₙ) which depends on the initial guest memories G₁, . . . , Gₙ. Similarly, let πᵢ(G₁, . . . , Gₙ) be an execution of the ideal system starting from an initial state linkⁱ(G₁, . . . , Gₙ). The top level proof goal is, thus, to prove that the g-traces of the real and the ideal system are identical, for all possible guests g and arbitrary G₁, . . . , Gₙ. In the deterministic case, executions are uniquely determined from the initial state, and it is sufficient to require that ωᵣ(πᵣ(G₁, . . . , Gₙ), g)=ωᵢ(πᵢ(G₁, . . . , Gₙ), g). In the non-deterministic case, it should be shown that the sets of possible traces for each initial state are the same, i.e. that for each real execution πᵣ(G₁, . . . , Gₙ) there is an ideal execution πᵢ(G₁, . . . , Gₙ) such that ωᵣ(πᵣ, g)=ωᵢ(πᵢ, g) and vice versa that for each ideal execution πᵢ(G₁, . . . , Gₙ) there is a real execution πᵣ(G₁, . . . , Gₙ) such that ωᵣ(πᵣ, g)=ωᵢ(πᵢ, g).

The g-trace equivalence can be proved using an unwinding (bi-simulation) condition according to any known or future methods. First, the unprivileged transition relations are introduced, i.e. the weak transition relations →ₙ⊆Δ×Δ and →ᵤ⊆S×S between states involving only machines that are not in a privileged mode. The states related by these transition relations are always in control of at least one guest. Referring again to FIG. 8, the thin line circles 801, 802, 805, 806, 851, 852, 855, 856 may represent states where the first guest is in control and the dashed arrows represent the unprivileged transitions.

A binary relationR⊆S×Δ is an observation-based bi-simulation if, for all (s₁, δ₁) ∈ R:

∀g.O_{g}^{r}(s₁)=O_{g}ⁱ(δ₁),

∀₂: if s₁→ᵤ s₂ then ∃δ₂ such that δ₁→ᵤ δ₂ and (s₂, δ₂) ∈ R, and

∀δ₂: if δ₁→_{u δ}₂ then ∃s₂ such that s₁→ᵤ s₂ and (s₂, δ₂) ∈ R.

Thus, the g-trace equivalence can be proved by exhibiting a candidate relation R that is a bi-simulation, which (for each possible initial guest memory content) relates the initial states of the real and ideal systems (i.e. init_{g}ⁱ(G₁, . . . , Gₙ) and init_{g}^{r}(G₁, . . . , Gₙ))

The candidate relation can be defined as a relation R such that (s, δ) ∈ R if and only if, for all g, Act_{g}^{r}(s)=Act_{g}ⁱ(δ), O_{g}^{r}(s)=O_{g}ⁱ(δ), Inv(s), and Inv(δ). The definition of the candidate relations depends on the kernel implementation, since Inv(s) and Inv (δ) contain the invariants that guarantee the correct execution of the software infrastructure (e.g. correct setup of the memory protection units and of the kernel data structures).

Establishing the bi-simulation relations depends on verifying properties of the formal model of the hosting machine and checking correctness of the kernel machine code. The latter may be based on Hoare Logic, where the triple {P}C{Q} may be used to represent a contract stating that when the pre-condition P is met, the execution of the machine code fragment C establishes the post-condition Q. The verification procedure can be subdivided into three main tasks: verification of the kernel boot, verification of user transitions, and verification of the kernel exception handlers.

Verification of Kernel Boot:

The kernel bootstrap terminates and correctly activates the same guest activated in the Top Level Specification, (init_{g}^{r}(G₁, . . . , Gₙ), init_{g}ⁱ(G₁, . . . , Gₙ)) ∈ R. Let P be a predicate that shows the initial state of the real machine. This property can be verified by checking the contract {P} bootstrap (init_{g}^{r}(G₁, . . . , Gₙ), init_{g}ⁱ(G₁, . . . , Gₙ)) ∈ R.

Verification of User Transitions:

Transitions performed in user mode (that do not raise an exception) guarantee that for all (s₁, δ₁) ∈ R such that M(s₁)=usr and M(δ₁)=usr, the following two conditions hold:

If s₁→s₂ and M(s₂)=usr, then there is a δ₂ such that δ₁→δ₂, M(δ₂)=usr, and (s₂, δ₂) ∈ R, and

If δ₁→δ₂ and M (δ₂)=usr, then there is a s₂ such that s₁→s₂, M (s₂)=usr, and (s₂, δ₂) ∈ R.

Typically, this property should be proved independently of the instruction executed by the guests. Moreover, the verification typically only depends on the security properties guaranteed by the CPU instruction set available in user mode and the system invariants guaranteed by the kernel (e.g. the set up of the page tables and memory protection unit).

Since, it is assumed for the ideal model that the observations of a guest depend only on the state of the corresponding machine, establishing this property depends on the verification of no-exfiltration and no-infiltration properties of the hosting machine:

No-exfiltration property states that the active functional module does not modify the resources that do not belong to it:

For each state s such that Inv(s), Act_{g}^{r}(s) and M(s)=usr, if s→s′and M(s′)=usr then unmodified (s, s′, g).

No-infiltration property states that the behavior of a functional module depends on its own resources:

For each state s₁ and s₂ such that Inv(s₁), Inv(s₂), Act_{g}^{r}(s₁), Act_{g}^{r}(s₂), M(s₁)=usr, and M (s₂)=usr, if s₁→s₁′and M (s₁′)=usr then there exists a state s₂′ such that s₂→s₂′, M(s₂′)=usr and O_{g}^{r}(s₁′)=O_{g}^{r}(s₂′).

Verification of Kernel Handlers:

Whenever a kernel handler is activated in the real system the corresponding ideal functionality is activated in the top level specification and vice versa. Moreover, the kernel handlers should correctly implement the ideal functionality. That is, for all (s₁, δ₁) ∈ R such that M(s₁)=M(δ₁)=usr, the following two conditions should hold:

If s₁→s₂→ᵤ s₃ and M(s₂)≠usr, then there is a δ₂ such that δ₁→δ₂, M(δ₂)=M(s₂), and (s₃, HY_{M(δ}_{₂}₎δ₂) ∈ R, and

If δ₁→δ₂ and M(δ₂)≠usr, then there is a s₂, s₃ such that s₁→s₂→ᵤ s₃, M(s₂)=M(δ₂), and (s₃, HY_{M(δ}_{₂}₎δ₂) ∈ R.

The state s₂ represents the state reached by the real system when an exception is raised. This is the state that activates the kernel handler for the raised exception. The state s₃ represents the first state in user mode reachable by the kernel exception handler, namely the state reached after the execution of the kernel activity.

Verifying the kernel handlers requires several steps:
Checking that, if a real and an ideal user state are in the candidate relation, they raise the same exception,
Verifying no-infiltration and no-exfiltration properties for the transitions that activate the privileged modes, and
Checking, for each kernel handler managing the exception that activates the privileged mode m, the contract {s₁→s Λ (s₁, δ₁) ∈ R_{g} Λ δ₁→δΛM(s)=M(δ)=m} handlerₘ {(s′, HY_{M} δ) ∈ R}.

The interface between the general proof and the kernel code verification may rely on Hoare logic. The general proofs delegate the verification of one or more contracts {P}C{Q} for each exception, namely, it should be verified that if the precondition P is met, then the kernel exception handler C establishes the post-condition Q. The verification of the contracts can be accomplished using any suitable known or future techniques. For example, a semi-automatic procedure involves computing the weakest pre-condition on the initial state (W=WP(C,Q)), i.e. the condition ensuring that the execution of C terminates in a state satisfying Q, and proving that the pre-condition entails the weakest precondition. This task can be fully automated if the predicate P=>W is equivalent to a predicate of the form: ∀x.F (or ∃x.F) where F is a quantifier free predicate: the validity of F (satisfiability of F) can be checked using a Satisfiability Modulo Theory (SMT) solver that supports bit vectors (e.g. STP as disclosed in V. Ganesh and D. L. Dill, “A decision procedure for bit-vectors and arrays”, in W. Damm and H. Hermanns, editors, CAV, volume 4590 of Lecture Notes in Computer Science, pages 519-531. Springer, 2007).

The top-level specification (TLS) and verification approach according to some embodiments disclosed herein is generally designed to take inter-component communication into account, which perfections the verification of information flow properties for real systems. A technique for building TLS may be based on communicating idealized low privileged mode processors that can be adopted in the para-virtualization context. The disclosed analysis approach can typically reach the machine code level.

To perform the verification, it is desirable to show that observation of all partitions when they execute on a hypervisor is identical to the case when they run on a dedicated correct-by-construction hardware. The observation of a guest typically comprises those resources of the system that a partition can see. To this end, the verification may comprise proving that, for all possible initial states and for all partitions, a partition's set of observable subtracts in the real/shared HW system and in the ideal/dedicated HW are identical.

It may be cumbersome to implement and realize the methods of FIGS. 4A and/or 4B directly. Therefore, a corresponding (more practical) example verification method is presented in FIG. 4C.

The proposed methodology according to some embodiments disclosed herein allows division of the verification into two distinguished main tasks; the verification of non-infiltration and no-exfiltration properties of the hosting machine (which depends on the system invariants and the protection mechanisms of the CPU itself), and the verification of the kernel handlers in the form on contracts (which represent the pre-post conditions of the exception handlers and system boot).

The verification may be divided into three parts: (a) verification that the system is initialized correctly, (b) verification of the system when partitions execute, and (c) verification of handlers as has been exemplified above.

The method of FIG. 4C comprises three parts:

(1) verification of the correct initialization of the system (114c, 161c, 196c),

(2) verification of the system while the partition is executing (120c, 162c, 194c), and

(3) verification of the kernel handlers (126c, 163c, 192c).

Step 110c is similar to step 110a of FIG. 4A and will not be elaborated on further. In step 113c, a correctness statement (security condition) is acquired.

The statement is checked (e.g. as exemplified above under verification of kernel boot) in step 161c for all relevant instructions (e.g. interrupts/exceptions) as illustrated by steps 114c, 161c, 196c and the loop back to 114c.

The statement is checked (e.g. as exemplified above under verification of user transitions) in step 162c for all relevant initial states as illustrated by steps 120c, 162c, 194c and the loop back to 120c.

The statement is checked (e.g. as exemplified above under verification of Kernel handlers) in step 163c for all functional modules (exceptions/interrupts) as illustrated by steps 126c, 163c, 192c and the loop back to 126c.

If any of the verifications fail (No-paths out from steps 161c, 162c, 163c) a non-satisfaction signal is generated in step 180c (compare with step 180a of FIG. 4A). If all verifications (steps 161c, 162c, 163c) are positive, a satisfaction signal is generated in step 170c (compare with step 170B of FIG. 4B).

Two or more of the verification of kernel boot (114c, 161c, 196c), the verification of user transitions (120c, 162c, 194c), and the verification of kernel handlers (126c, 163c, 192c) may be performed in another order than that shown in FIG. 4C or partly or fully in parallel.

In an example implementation of the method of FIG. 4C, there may be several software components that, together, perform the verification. For example: one component can check initialization, one component (e.g. ARM Prover and Hol4) can check partition transitions, and one component (e.g. BAP) can check the handlers. An example of such an implementation is schematically illustrated in FIG. 12.

In FIG. 12, the model and shared hardware blocks (MODEL) 1210 and (S.HW) 1203 may comprise respective representations of the operations of execution using the model and the shared hardware in a manner similar to what has been described above in connection with FIG. 11. The selector (SEL) 1211 may be adapted to control the operations of the verifiers 1251, 1252, 1253 such that all relevant instructions, initial states and functional modules are processed in the respective verifier (compare with steps 196c, 194c, 192c of FIG. 4C).

The instruction verifier (INS VER) 1251 may be adapted to perform step 161c of FIG. 4C, the initial state verifier (INIT VER) 1252 may be adapted to perform step 162c of FIG. 4C and the handler verifier (HANDL VER) 1253 may be adapted to perform step 163c of FIG. 4C.

The determiner (DET) 1218 is adapted to determine whether or not the security (isolation) condition is satisfied based on the result from blocks 1251, 1252 and 1253 and instruct the signal generator (SIGNGEN) 1219 to output a signal accordingly. For example, the determiner 1218 and the signal generator 1219 may implement steps 180c and 170c of FIG. 4C.

The described embodiments and their equivalents may be realized in software or hardware or a combination thereof. They may be performed by general-purpose circuits associated with or integral to a communication device, such as digital signal processors (DSP), central processing units (CPU), co-processor units, field-programmable gate arrays (FPGA) or other programmable hardware, or by specialized circuits such as for example application-specific integrated circuits (ASIC). All such forms are contemplated to be within the scope of this disclosure.

Embodiments may appear within an electronic apparatus (such as a wireless communication device or a computer) comprising circuitry/logic or performing methods according to any of the embodiments. The electronic apparatus may, for example, be a portable or handheld mobile radio communication equipment, a computer, or a USB-stick.

According to some embodiments, a computer program product comprises a computer readable medium such as, for example, a diskette or a CD-ROM (as illustrated by 1200 of FIG. 12). The computer readable medium may have stored thereon a computer program comprising program instructions. The computer program may be loadable into a data-processing unit (1230), which may, for example, be comprised in a computing device (1210). When loaded into the data-processing unit, the computer program may be stored in a memory (1220) associated with or integral to the data-processing unit. According to some embodiments, the computer program may, when loaded into and run by the data-processing unit, cause the data-processing unit to execute method steps according to, for example, the method shown in FIG. 4A.

A few example embodiments include:

1. A method of specifying isolation properties between two or more security domains, wherein execution associated with the two or more security domains is performed by a shared security kernel using a set of shared hardware resources, the method comprising modeling the execution associated with the two or more security domains on the set of shared hardware resources by corresponding execution on a set of dedicated respective hardware resources.

2. The method of example 1, wherein the execution on the set of shared hardware resources and the execution on the set of dedicated respective hardware resources both comprises two or more execution modes.

3. The method of example 2, wherein each execution mode is associated with a respective security domain.

4. The method of any of examples 1 through 3 wherein the dedicated respective hardware resources comprise one set of hardware resources for each of the two or more security domains, the set of hardware resources for any of the security domains being physically separated from the set of hardware resources for each other of the security domains, and a shared data structure handler operatively connected to the set of hardware resources for each of the two or more security domains.

5. The method of example 4, wherein the isolation properties are specified by the shared data structure handler.

6. The method of any of examples 4 through 5 further comprising verifying the isolation properties via observation-based bi-simulation of the execution on the set of shared hardware resources and of the corresponding execution on the set of dedicated respective hardware resources.

7. The method of example 6, wherein respective information exchange authorization parameters define whether or not an information exchange between two of the security domains is authorized and wherein the isolation properties are verified if the bi-simulation shows only authorized information exchange.

8. The method of any of examples 1 through 7, wherein the shared hardware resources comprises at least a memory unit storing data related to each of the two or more security domains and wherein the isolation properties comprise a condition that data related to a first one of the two or more security domains is independent of data related to a second one of the two or more security domains.

9. A method of verifying isolation properties between two or more security domains, wherein execution associated with the two or more security domains is performed by a shared security kernel using a set of shared hardware resources, the method comprising modeling the execution associated with the two or more security domains on the set of shared hardware resources by corresponding execution on a set of dedicated respective hardware resources, verifying that all information exchange between the dedicated respective hardware resources is authorized information exchange, and verifying that there is only authorized interactions between the security domains via operation of the security kernel. According to some embodiments, the partition can execute on the hardware directly (i.e. the execution is not performed by the hypervisor) but when the partitions want to do some particular operations, the hypervisor intercepts.

10. A computer program product comprising a computer readable medium, having thereon a computer program comprising program instructions, the computer program being loadable into a data-processing unit and adapted to cause execution of the method according to any of examples 1 through 9 when the computer program is run by the data-processing unit.

11. A system comprising a set of hardware resources, a security kernel, and a top level specification, wherein the set of hardware resources is shared between two or more security domains, the security kernel is adapted to perform execution associated with the two or more security domains using the set of hardware resources, and top level specification is adapted to model the execution associated with the two or more security domains on the set of shared hardware resources by corresponding execution on a set of dedicated respective hardware resources.

12. The system of example 11 adapted to perform the method according to any of examples 1 through 9.

13. An electronic device comprising the system according to any of examples 11 through 12.

Reference has been made herein to various embodiments and examples. However, a person skilled in the art would recognize numerous variations to the described embodiments that would still fall within the scope of the claims. For example, the method embodiments described herein describes example methods through method steps being performed in a certain order. However, it is recognized that these sequences of events may take place in another order without departing from the scope of the claims. Furthermore, some method steps may be performed in parallel even though they have been described as being performed in sequence.

In the same manner, it should be noted that in the description of embodiments, the separation of functional blocks into particular units is by no means limiting. Contrarily, these partitions are merely examples. Functional blocks described herein as one unit may be split into two or more units. In the same manner, functional blocks that are described herein as being implemented as two or more units may be implemented as a single unit without departing from the scope of the claims.

Hence, it should be understood that the details of the described embodiments are merely for illustrative purpose and by no means limiting. Instead, all variations that fall within the range of the claims are intended to be embraced therein.

1. A security condition verification method for a system comprising first and second security domains relating to respective first and second functional modules, a security kernel and a shared hardware component, wherein:
each of the first and second functional modules is adapted to be executed using the shared hardware component;
the security condition comprises a condition that any piece of information, originating from executing a first one of the functional modules and affecting execution of a second one of the functional modules, belongs to a set of authorized information exchange between the first and second security domains; and
the security kernel is adapted to control the execution of the first and second functional modules using the shared hardware component,
the method comprising:
determining that the security condition is satisfied if, for each of the functional modules, for each initial state, and for each instruction, a first observable parameter associated with execution of the instruction of the functional module under control of the security kernel using the shared hardware component having the initial state equals a second observable parameter associated with execution of the instruction of the functional module using a dedicated model hardware component having the initial state, the dedicated model hardware component belonging to a model of the system wherein each functional module is adapted to be executed using a respective dedicated model hardware component and the set of authorized information exchange is represented by a communication unit operatively connected to each of the dedicated model hardware components via a respective security handler representing the security kernel control; and
generating a security condition satisfaction signal if it is determined that the security condition is satisfied.

2. The method of claim 1, wherein the shared hardware component comprises a memory unit storing memory data related to the first and second functional module, wherein the first and second observable parameters are indicative of a corresponding content of the memory unit, and wherein the security condition comprises a condition that memory data related to the execution of the first functional module is not accessible during execution of the second functional module.

3. The method of claim 1, wherein the shared hardware component comprises a processor with a register unit, wherein the first and second observable parameters are indicative of a corresponding content of the register unit, and wherein the security condition comprises a condition that content of the register unit related to the execution of the first functional module is not altered during execution of the second functional module.

4. The method of claim 1 further comprising:
determining that the security condition is not satisfied if, for at least one of the functional modules, initial states, and instructions, the first observable parameter is not equal to the second observable parameter; and
generating a security condition non-satisfaction signal if it is determined that the security condition is not satisfied.

5. The method of claim 1, wherein determining that the security condition is satisfied comprises:
determining, for each functional module, that the functional module has identical observations in a state of the shared hardware component after execution of bootstrap code of the security kernel and in an initial state of the dedicated model hardware component;
determining, for each instruction and for each functional module, that execution of the instruction by the functional module on the shared hardware component has a corresponding state transition from a corresponding state on the dedicated model hardware component, and that execution of the instruction by the functional module on the shared hardware component and execution of the instruction on the dedicated model hardware component lead to a states that have equal observations; and
determining, for each functional module, that an exception raised in a particular state of the dedicated model hardware component has a corresponding exception of the security kernel for a corresponding state of the shared hardware component, and that observations of the functional module after handling the exception of the dedicated model hardware component are equal to observations of the functional module after handling the corresponding exception of the shared hardware component.

6. The method of claim 1, wherein determining that the security condition is satisfied comprises:
initiating the shared hardware component to the initial state;
executing an instruction sequence comprising the instruction under control of the security kernel using the shared hardware component while producing a corresponding first execution trace indicative of a sequential list of states of the shared hardware component, wherein the first observable parameter comprises the first execution trace;
initiating the dedicated model hardware component to the initial state; and
executing the instruction sequence using the dedicated model hardware component and the model communication unit while producing a corresponding second execution trace indicative of a sequential list of states of the dedicated model hardware component, wherein the second observable parameter comprises the second execution trace.

7. A computer program product comprising a computer readable medium, having thereon a computer program comprising program instructions, the computer program being loadable into a data-processing unit (1330) and adapted to cause execution of the method according to claim 1 when the computer program is run by the data-processing unit.

8. A security condition verification arrangement for a system comprising first and second security domains relating to respective first and second functional modules, a security kernel and a shared hardware component, wherein:
each of the first and second functional modules is adapted to be executed using the shared hardware component;
the security condition comprises a condition that any piece of information, originating from executing a first one of the functional modules and affecting execution of a second one of the functional modules, belongs to a set of authorized information exchange between the first and second security domains; and
the security kernel is adapted to control the execution of the first and second functional modules using the shared hardware component,
the arrangement comprising:
a determiner adapted to determine that the security condition is satisfied if, for each of the functional modules, for each initial state, and for each instruction, a first observable parameter associated with execution of the instruction of the functional module under control of the security kernel using the shared hardware component having the initial state equals a second observable parameter associated with execution of the instruction of the functional module using a dedicated model hardware component having the initial state, the dedicated model hardware component belonging to a model of the system wherein each functional module is adapted to be executed using a respective dedicated model hardware component and the set of authorized information exchange is represented by a communication unit operatively connected to each of the dedicated model hardware components via a respective security handler representing the security kernel control; and
a signal generator adapted to generate a security condition satisfaction signal responsive to the determiner determining that the security condition is satisfied.

9. The arrangement of claim 8, wherein the shared hardware component comprises a memory unit storing memory data related to the first and second functional module, wherein the first and second parameters are indicative of a corresponding content of the memory unit, and wherein the security condition comprises a condition that memory data related to the execution of the first functional module is not accessible during execution of the second functional module.

10. The arrangement of claim 8, wherein the shared hardware component comprises a processor with a register unit, wherein the first and second parameters are indicative of a corresponding content of the register unit, and wherein the security condition comprises a condition that content of the register unit related to the execution of the first functional module is not altered during execution of the second functional module.

11. The arrangement of claim 8, further comprising:
an initiation verifier adapted to determine, for each functional module, whether the functional module has identical observations in a state of the shared hardware component after execution of bootstrap code of the security kernel and in an initial state of the dedicated model hardware component;
an instruction verifier adapted to determine, for each instruction and for each functional module, whether execution of the instruction by the functional module on the shared hardware component has a corresponding state transition from a corresponding state on the dedicated model hardware component, and whether execution of the instruction by the functional module on the shared hardware component and execution of the instruction on the dedicated model hardware component lead to a states that have equal observations; and
a handler verifier adapted to determine, for each functional module, whether an exception raised in a particular state of the dedicated model hardware component has a corresponding exception of the security kernel for a corresponding state of the shared hardware component, and whether observations of the functional module after handling the exception of the dedicated model hardware component are equal to observations of the functional module after handling the corresponding exception of the shared hardware component; and
wherein the determiner is adapted to determine that the security condition is satisfied responsive to the determinations from the instruction verifier, the initiation verifier and the handler verifier.

12. The arrangement of claim 8 further comprising the first and second functional modules, the security kernel and the shared hardware component.

13. An electronic device comprising the arrangement according to claim 8.
